(19) United States
(12) Patent Application Publication
(10) Pub. No.: US 2019/0337128 A1
(43) Pub. Date: Nov. 7, 2019

(54) Elastic Member of Pawl Control Mechanism of Ratchet Tool

(71) Applicant: RE-DAI PRECISION TOOLS CO.,LTD., Taichung (TW)

(72) Inventor: Chen-Han Lee, Taichung (TW)

(21) Appl. No.: 16/037,012

(22) Filed: Jul. 17, 2018

(30) Foreign Application Priority Data
May 7, 2018 (TW) 107115373

(51) Int. Cl. B25B 13/46

(52) U.S. Cl. CPC B25B 13/463

(57) ABSTRACT

A ratchet tool includes a head portion, a ratchet mechanism, and a pawl control mechanism. The ratchet mechanism includes a gear wheel and a pawl in tooth engagement. The gear wheel is rotatably mounted on the head portion. The pawl is movably mounted on the head portion. The pawl control mechanism includes a pusher urged by an elastic member. The pusher includes a first end against the pawl and a second end against the elastic member. The elastic member is selectively compressed by the pusher. The elastic member includes at least one limiting portion of a first internal diameter against the second end of the pusher. The elastic member includes a plurality of compressible portions and the compressible portion adjacent to the at least one limiting portion is of a second internal diameter. The first internal diameter is less than the second internal diameter.

### BACKGROUND OF THE INVENTION

### 1. Field of the Invention

The present invention relates to a ratchet tool and, particularly, to a pawl control mechanism of a ratchet tool and, more particularly, to an elastic member of the pawl control mechanism.

### 2. Description of the Related Art

TW Pat. No. 408653 shows a ratchet tool with a ratchet mechanism including a gear wheel and a pawl in tooth engagement with the gear wheel. The pawl is selectively movable between a position in which the gear wheel is allowed to rotate clockwise and prevented from rotating counterclockwise, a position in which the gear wheel is allowed to rotate counterclockwise and prevented from rotating clockwise, and a position in which the gear wheel is prevented from rotating either clockwise or counterclockwise. Furthermore, the pawl is actuated by a pawl control mechanism and changes positions upon operation of the pawl control mechanism. The pawl control mechanism includes a control input, an engaging pin, and an elastic member. The engaging pin has one end retained on the control input and another end retained on the pawl respectively. The elastic member has one end retained on the control input and another end retained on the engaging pin and. The engaging pin is urged by the elastic member to push the pawl toward the gear wheel.

It is noted that rotations of the gear wheel are often not smooth and the teeth of pawl and the gear wheel are not engaged properly.

The present invention is, therefore, intended to obviate or at least alleviate the problems encountered in the prior art.

### SUMMARY OF THE INVENTION

According to the present invention, a ratchet tool includes a head portion, a ratchet mechanism, and a pawl control mechanism. The head portion has a first second and third compartment communicated with one another, and the third compartment is located between the first and second compartments. The ratchet mechanism includes a gear wheel and a pawl engaged with the gear wheel in tooth engagement. The gear wheel is rotatably mounted on the head portion and positioned in the first compartment. The gear wheel includes a plurality of first teeth disposed circumferentially on an outer periphery thereof. The pawl is movably mounted on the head portion and is positioned in the third compartment. The pawl includes a plurality of second teeth disposed on a first side thereof and engaged with the plurality of first teeth. The pawl control mechanism includes a pusher and an elastic member urging the pusher. The pusher includes a first end against the pawl and pushes the pawl toward the gear wheel and a second end against the elastic member. The elastic member is selectively compressed by the pusher. The elastic member includes at least one limiting portion of a first internal diameter at a first end thereof and against the second end of the pusher. The elastic member includes a plurality of compressible portions and the compressible portion adjacent to the at least one limiting portion has a second internal diameter. The first internal diameter is less than the second internal diameter.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is an exploded perspective view of a ratchet tool in accordance with a first embodiment of the present invention;

FIG. 2 is a perspective view showing an elastic member used in the ratchet tool;

FIG. 3 is a partial, cross-sectional view of the ratchet tool;

FIG. 4 is an enlarged cross-sectional view of FIG. 3; and

FIG. 5 is a cross-sectional view showing a pusher of a design different from that shown in FIG. 4.

### DETAILED DESCRIPTION OF THE INVENTION

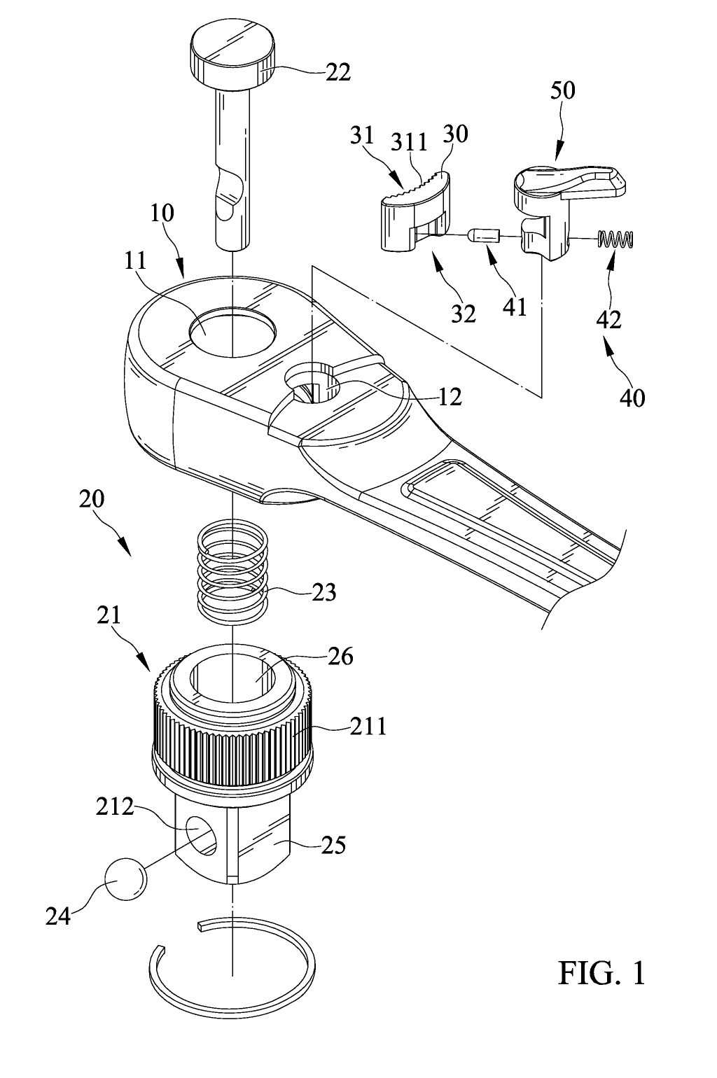

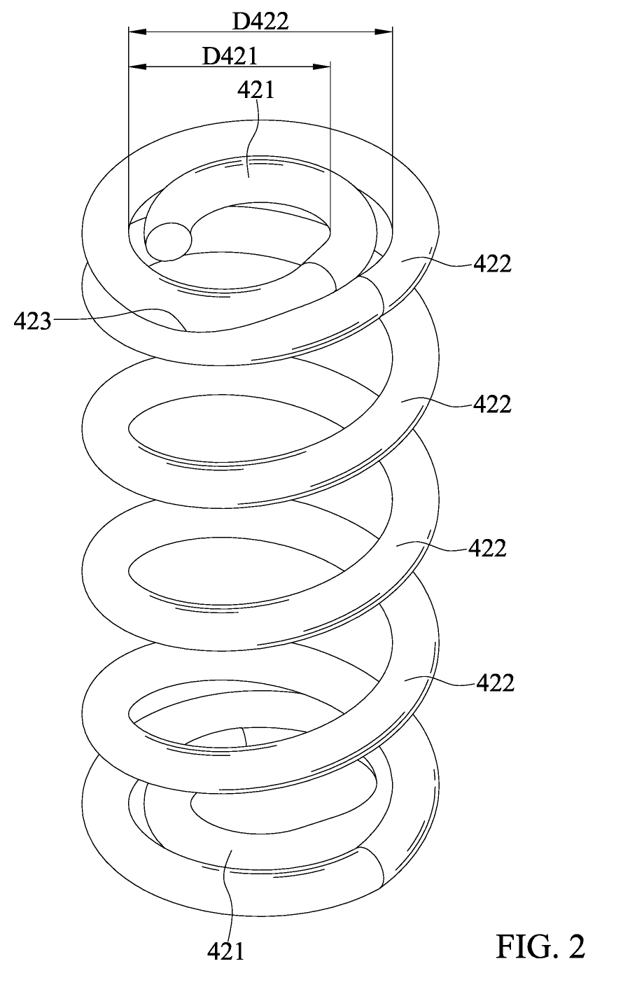

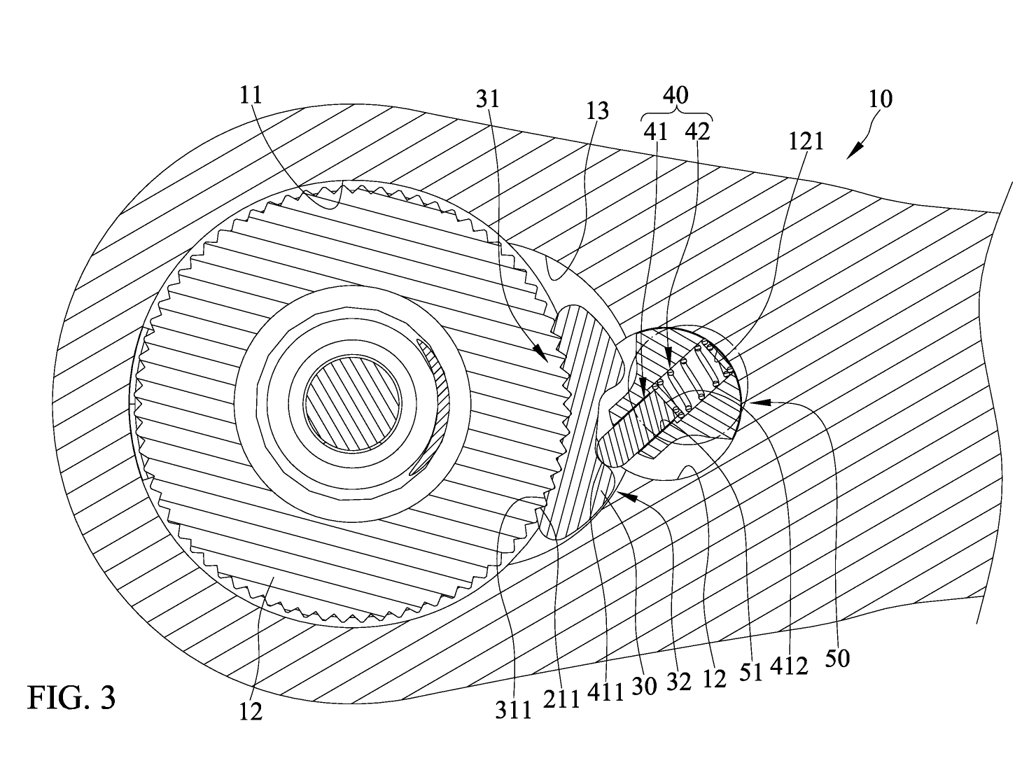

As shown in FIGS. 1 through 4, a ratchet tool includes a head portion 10 having a first, second and third compartment 11, 12, and 13 communicated with one another, and the third compartment 13 is located between the first and second compartments 11 and 12.

A ratchet mechanism 20 includes a gear wheel 21 and a pawl 30 engaged with the gear wheel 21 in tooth engagement. The gear wheel 21 is rotatably mounted on the head portion 10 and positioned in the first compartment 11. The gear wheel 21 includes a plurality of first teeth 211 disposed circumferentially on an outer periphery thereof. The pawl 30 is movably mounted on the head portion 10 and is positioned in the third compartment 13. The pawl 30 includes a plurality of second teeth 311 disposed on a first side 31 thereof and engaged with the plurality of first teeth 211. The gear wheel 21 includes a protrusion 25 extending therefrom. The gear wheel 21 and the protrusion 25 include an orifice 26 extending therein. The orifice 26 has a first section surrounded by the plurality of the first teeth 211 and a second section extending in the protrusion 25 respectively. The protrusion 25 includes an aperture 212 extending radially from the orifice 26. The aperture 212 includes a detent ball 24 movably disposed therein. The orifice 26 includes a shaft 22 movably disposed therein. The shaft 22 is urged by the biasing member 23. The shaft 22 includes recesses of different depths and the detent ball 24 is selectively disposed on the recesses in response to movement of the shaft 22.

A pawl control mechanism 40 includes a pusher 41 and an elastic member 42 urging the pusher 41. The pusher 41 includes a first end 411 against the pawl 30 and pushes the pawl 30 toward the gear wheel 21 and a second end 412 against the elastic member 42. The first end of the pusher 41 is against a second side 32 of the pawl 30. Specifically, the second side 32 includes a concave section and the first end of the pusher 41 is retained in the concave section. The elastic member 42 is selectively compressed by the pusher 41. The elastic member 42 includes at least one limiting portion 421 of a first internal diameter D421 at a first end thereof and against the second end 412 of the pusher 41. Preferably, the at least one limiting portion 421 includes two limiting portions 421 at opposite ends of the elastic member 42. The second end of the pusher 41 has a size small than the first internal diameter of the limiting portion 421 of the pusher 41. The at least one limiting portion 421 is in the form of a loop. The elastic member 42 also includes a plurality of compressible portions 422. Each of the plurality of compressible portions 422 is in the form of a loop. The compressible portion 422 adjacent to the at least one limiting portion 421 extends from a distal end of the at least one limiting portion 421. The compressible portion 422 adjacent to the at least one limiting portion 421 has a length of circumference radially spaced from a length of circumference of the at least one limiting portion 421. The at least one limiting portion 421 includes a section 423 partially contacted with the compressible portion 422 adjacent to the at least one limiting portion 421. The plurality of compressible portions 422 is connected with one another in series and aligned axially along an axis L and has a pitch between two adjacent compressible portions 422. The compressible portion 422 adjacent to the at least one limiting portion 421 has a second internal diameter D422. The first and second internal diameters D421 and D422 have a same end point. The first internal diameter D421 is less than the second internal diameter D422. Furthermore, the ratio between the first internal diameter D421 and the second internal diameter D422 is in a range between 0.5 and 0.9.

A control input 50 is movably mounted on the head portion 10 and positioned in the second compartment 12. The pusher 41 is engaged with and includes the first end 411 movably against the pawl 30 in response to movement of the control input 50. The control input 50 includes a hole 51 extending therein. The hole 51 is a through hole. The hole 51 has a small section 511 and a large section 512 aligned axially. An internal diameter D512 of the large section 512 is greater than an internal diameter D511 of the small section 511. The hole 51 forms a shoulder 513 extending radially between peripheries of the small and large sections 511 and 512. The pusher 41 and the elastic member 42 are disposed in the hole 51. The elastic member 42 includes a second end through the hole 51 and against a wall 121 of the second compartment 12.

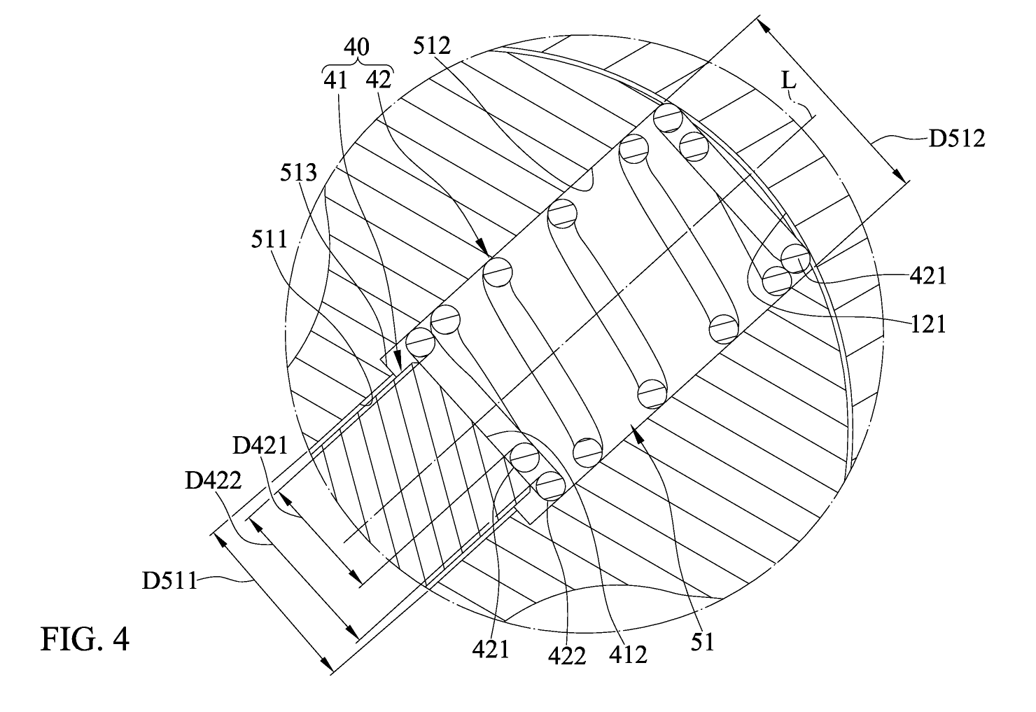

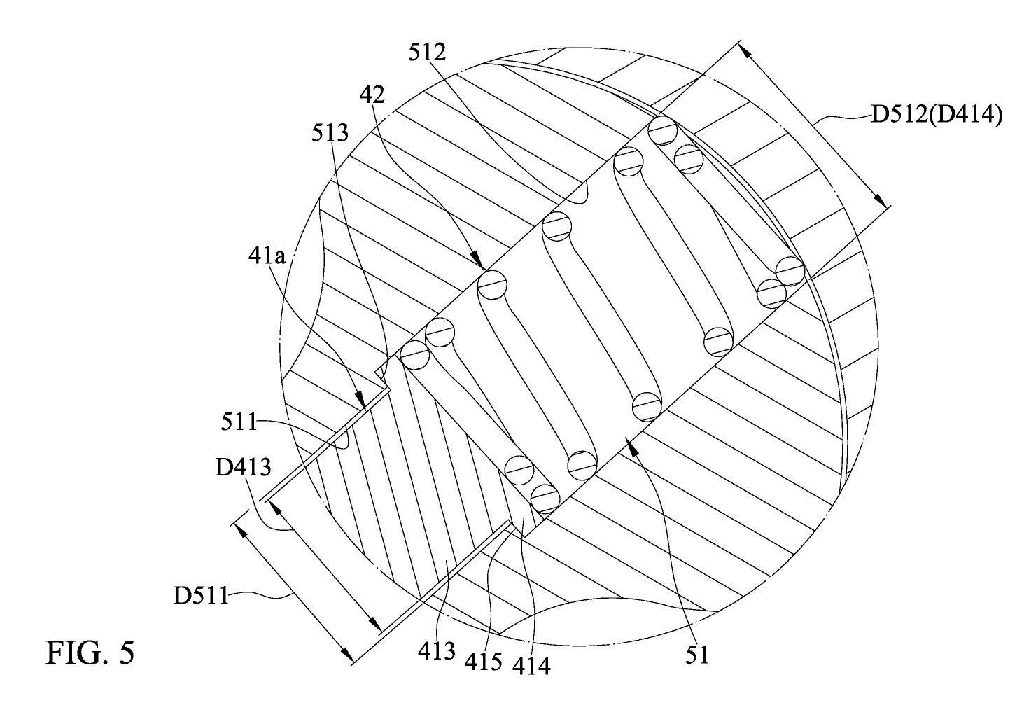

FIG. 5 shows a pusher 41a of a design different from that shown in FIG. 4. The pusher 41a includes a flange with a side 415 adapted to be retained on and in surface contact with the shoulder 513. The pusher 41a has a small section 413 of and a large section 414. The small section 413 is of an external diameter D413. The large section 414 is of an external diameter D414. The external diameter D414 is greater than the external diameter D413. The side 415 forms the large section 414.

In view of the forgoing, the pushers 41 and 41a and the at least one limiting portion 421 of the elastic member 42 are flatly contacted with each other to maintain the pushers 41 and 41a in a stable path. The at least one limiting portion 421 also prevents the pushers 41 and 41a from dropping into the space of each of the plurality of the compressible portions 422.

The foregoing is merely illustrative of the principles of this invention, and various modifications can be made by those skilled in the art without departing from the scope and spirit of the invention.

What is claimed is:

1. A ratchet tool comprising:
a head portion having a first, second and third compartment communicated with one another, and wherein the third compartment is located between the first and second compartments;
a ratchet mechanism including a gear wheel and a pawl engaged with the gear wheel in tooth engagement, wherein the gear wheel is rotatably mounted on the head portion and positioned in the first compartment, wherein the gear wheel includes a plurality of first teeth disposed circumferentially on an outer periphery thereof, wherein the pawl is movably mounted on the head portion and is positioned in the third compartment, wherein the pawl includes a plurality of second teeth disposed on a first side thereof and engaged with the plurality of first teeth; and
a pawl control mechanism including a pusher and an elastic member urging the pusher, wherein the pusher includes a first end against the pawl and pushes the pawl toward the gear wheel and a second end against the elastic member, wherein the elastic member is selectively compressed by the pusher, wherein the elastic member includes at least one limiting portion of a first internal diameter at a first end thereof and against the second end of the pusher, wherein the elastic member includes a plurality of compressible portions and the compressible portion adjacent to the at least one limiting portion has a second internal diameter, and wherein the first internal diameter is less than the second internal diameter.
The first end of the pusher 41 is against a second side 32 of the pawl 30. Specifically, the second side 32 includes a concave section and the first end of the pusher 41 is retained in the concave section.

2. The ratchet tool as claimed in claim 1, wherein the ratio between the first internal diameter and the second internal diameter is in a range between 0.5 and 0.9.

3. The ratchet tool as claimed in claim 1, wherein the second end of the pusher has a size small than the first internal diameter of the limiting portion of the pusher.

4. The ratchet tool as claimed in claim 1, wherein the compressible portion adjacent to the at least one limiting portion has a length of circumference radially spaced from a length of circumference of the at least one limiting portion, and wherein first and second internal diameters have a same end point.

5. The ratchet tool as claimed in claim 1, wherein each of the at least one limiting portion and the plurality of compressible portions is in the form of a loop, wherein the compressible portion adjacent to the at least one limiting portion extends from a distal end of the at least one limiting portion, and wherein the plurality of compressible portions is connected with one another in series and aligned axially along an axis L and has a pitch between two adjacent compressible portions.

6. The ratchet tool as claimed in claim 4, wherein each of the at least one limiting portion and the plurality of compressible portions is in the form of a loop, wherein the compressible portion adjacent to the at least one limiting portion extends from a distal end of the at least one limiting portion, and wherein the plurality of compressible portions is connected with one another in series and aligned axially and has a pitch between two adjacent compressible portions.

7. The ratchet tool as claimed in claim 6, wherein the ratio between the first internal diameter and the second internal diameter is in a range between 0.5 and 0.9.

8. The ratchet tool as claimed in claim 7, wherein the second end of the pusher has a size small than the first internal diameter of the limiting portion of the pusher.

9. The ratchet tool as claimed in claim 6, wherein the at least one limiting portion includes a section partially contacted with the compressible portion adjacent to the at least one limiting portion.

10. The ratchet tool as claimed in claim 1, wherein the pawl control mechanism includes a control input movably mounted on the head portion and positioned in the second compartment, wherein the pusher is engaged with and includes the first end movably against the pawl in response to movement of the control input, wherein the control input includes a hole extending therein, and wherein the pusher and the elastic member are disposed in the hole.

11. The ratchet tool as claimed in claim 10, wherein the compressible portion adjacent to the at least one limiting portion has a length of circumference radially spaced from a length of circumference of the at least one limiting portion, and wherein first and second internal diameters have a same end point.

12. The ratchet tool as claimed in claim 11, wherein each of the at least one limiting portion and the plurality of compressible portions is in the form of a loop, wherein the compressible portion adjacent to the at least one limiting portion extends from a distal end of the at least one limiting portion, and wherein the plurality of compressible portions is connected with one another in series and aligned axially and has a pitch between two adjacent compressible portions.

13. The ratchet tool as claimed in claim 12, wherein the ratio between the first internal diameter and the second internal diameter is in a range between 0.5 and 0.9.

14. The ratchet tool as claimed in claim 10, wherein the hole has a small section and a large section aligned axially, and wherein an internal diameter of the large section is greater than an internal diameter of the small section.

15. The ratchet tool as claimed in claim 14,wherein the hole forms a shoulder extending radially between peripheries of the small and large sections, and wherein the pusher includes a flange with a side adapted to be retained on and in surface contact with the shoulder.

16. The ratchet tool as claimed in claim 14, wherein the hole is a through hole and the elastic member includes a second end against a wall of the second compartment.

17. The ratchet tool as claimed in claim 1, wherein the at least one limiting portion includes two limiting portions at opposite ends of the elastic member.

18. The ratchet tool as claimed in claim 1, wherein the gear wheel includes a protrusion extending therefrom, wherein the gear wheel and the protrusion include an orifice extending therein, wherein the orifice has a first section surrounded by the plurality of the first teeth and a second section extending in the protrusion respectively, wherein the protrusion includes an aperture extending radially from the orifice, wherein the aperture includes a detent ball movably disposed therein, wherein the orifice includes a shaft movably disposed therein, wherein the shaft is urged by the biasing member, and wherein the shaft includes recesses of different depths and the detent ball is selectively disposed on the recesses in response to movement of the shaft.

19. An elastic member of a pawl control mechanism of a ratchet tool comprising:
a compressible one-piece body coiled spirally and includes at least one limiting portion of a first internal diameter at a first end thereof and a plurality of compressible portions connected with one another in series and aligned axially, wherein the compressible portion adjacent to the at least one limiting portion has a second internal diameter, and wherein the first internal diameter is less than the second internal diameter.

20. The ratchet tool as claimed in claim 19, wherein the compressible portion adjacent to the at least one limiting portion has a length of circumference radially spaced from a length of circumference of the at least one limiting portion, and wherein first and second internal diameters have a same end point.
